(19) United States
(12) Patent Application Publication
(10) Pub. No.: US 2003/0036986 A1
(43) Pub. Date: Feb. 20, 2003

(54) Systems and methods of determining a billing amount for examining equipment in industrial plants

(76) Inventor: Jonathon M. Bird, Anaheim, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/760,943

(22) Filed: Jan. 15, 2001

Related U.S. Application Data
(60) Provisional application No. 60/176,541, filed on Jan. 18, 2000.
(60) Provisional application No. 60/207,977, filed on May 30, 2000.

(51) Int. Cl. G06F 17/60

(52) U.S. Cl. 705/34; 705/1

(57) ABSTRACT

A system and method determine a billing amount for examining equipment in industrial plants and other complex systems. The system and method compensate technicians for examining the equipment. A service provider or technician conducts an initial inspection of the industrial plant and determines a base rate for examining a system point in the industrial plant. A delay time rate, which is the rate for billing an examining technician's time of waiting through no fault of the technician or the service provider, is also determined. For each examined system point, the technician determines if the system point corresponds to any of the pre-determined special condition/add-on rate pairs. The technician records the corresponding special condition/add-on rate pairs. The technician also records the number of system points examined or records the base rate for each system point examined. The technician also records delay time incurred for the system point. For each system point examined, the technician or the service provider adds together the base rate, the corresponding add-on rates, and the delay time multiplied by the delay time rate to produce the billing amount for the system point. The technician or the service provider determines the total billing amount for the examination by adding together billing amount for all system points. The technician is paid at least in part a percentage of the total billing amount.

### CROSS REFERENCE TO RELATED APPLICATIONS

This application claims priority from U.S. Provisional Patent Application No. 60/176,541, titled “Ultrasonic Thickness Efficiency System” and filed Jan. 18, 2000. This application also claims priority from U.S. Provisional Patent Application No. 60/207,977, titled “The Sure Point System” and filed May 30, 2000.

### BACKGROUND OF THE INVENTION

1. Field of the Invention

This invention relates to systems and methods of determining a billing amount for examining equipment such as pipes, valves, tanks, vessels and the like, in industrial plants and other complex systems. This invention also relates to systems and methods of measuring technician performance and compensating technicians for examining the equipment.

2. Description of the Related Art

Equipment in complex systems such as industrial plants often requires examination to ensure the equipment is in proper working order. For example, systems of pipes, valves, pumps and the like in industrial plants such as refineries, chemical plants and power plants require examination to determine the degree of erosion, corrosion and other damage. Examinations may include visual inspection, thickness or distance measuring, ultrasonic testing, radiographic testing, liquid penetration testing, or other types of testing and examination performed by one or more technicians. Examinations may also include, for example, developing field drawings to identify and describe the equipment in an industrial plant, reading and recording data displayed on equipment, and so forth. Technicians are typically hired and paid by a service provider. The service provider contracts with a customer to perform the examination service using the technicians. This application will refer to the service provider throughout the application, although it should be understood that technicians may also independently contract with a customer or be hired by the customer to perform the examination service. The customer is the party that requests and pays the service provider or the independent technicians for the examination. The customer is usually the party that owns or maintains the industrial plant.

Technicians are often paid an hourly rate to perform the examinations. Technicians report the number of hours to complete an examination. They are paid a flat hourly rate multiplied by the number of hours. The hourly rate scheme is easy to implement but does not motivate the technicians to work efficiently. The hourly rate scheme in fact discourages technicians from working efficiently. Since the hourly rate stays the same regardless of a technician's efficiency, a technician may be tempted to spend or report a more than necessary number of hours on the examination. It is possible to envision an alternative scheme where technicians are paid by the number of system points they examine. A system point refers to a unit in an industrial plant that requires examination. Such a scheme would motivate technicians to work efficiently to examine as many system points as possible in a given time frame, but does not distinguish system points that are easy or less time consuming to examine from system points that are difficult or more time consuming to examine. For example, examining one system point located on the ground level requires testing at the ground level, while examining another system point located above ground requires the technician to climb up a ladder to perform the same type of testing. Therefore, this scheme would not motive technicians to examine all types of system points.

Similar problems occur in billing a customer for the examinations. If the customer is billed an hourly rate multiplied by a number of hours spent on the examination, the number of hours is likely to be more than the time that is needed to complete the examination, because the technicians may be tempted to spend more than the necessary hours on the examination, as discussed above.

In another scheme, the customer is billed a flat rate regardless of the number of hours the technicians spend. The service provider conducts a brief pre-examination inspection of the industrial plant, and provides the customer with an estimated flat rate quote. Since this flat rate is-based on a brief inspection, it is quite likely that the flat rate does not accurately reflect the number of hours the technicians spend or should spend on the examination. Such a flat rate scheme also does not give the customer enough information regarding how the flat rate is calculated and the examination difficulty of all system points.

On the other hand, if the service provider evaluates all the system points in the industrial plant to produce a flat rate estimate that takes into account the examination difficulty of all system points, such an evaluation process may take too long and may require too much manpower to complete. Such an evaluation also does not take into account delay time encountered by technicians through no fault of the technicians or the service provider. For example, the customer may have neglected to have ladders ready for technicians to examine above-ground system points. In this case the technicians and the service provider ought to be reasonably compensated for the delay time.

### SUMMARY OF THE INVENTION

One aspect of the present invention is a system and method of compensating technicians such that technicians are motivated to complete an examination in the shortest number of hours possible, and such that the technicians are equally motivated to examine easy-to-examine system points and difficult-to-examine system points. Another aspect of the present invention is a system and method of billing for examinations that does not unfairly penalize the technicians or the service provider for delays that are not fault of the technicians or the service provider.

Yet another aspect of the present invention is a system and method that provides a reasonably accurate estimate of cost to the customer in a reasonably quick manner. Still another aspect of the present invention is a system and method of determining a billing amount that reflects the amount of time required for motivated technicians to complete the examination.

In one embodiment of the system and method, a service provider or technician conducts an initial inspection of the industrial plant and provides a customer with an estimate of the cost of examination. The service provider or technician determines a base rate for examining a system point in the industrial plant. Alternatively the service provider or technician determines a base amount for examining all system points in the industrial plant. A delay time rate, which is the rate for billing an examining technician's time of waiting through no fault of the technician or the service provider, is also determined and provided to the customer. For each examined system point, the technician determines if the system point corresponds to any of the predetermined special condition/add-on rate pairs. The technician records the corresponding special condition/add-on rate pairs by recording the special condition, recording the add-on rate, or recording a code representing the pair. The technician also records the number of system points examined or records the base rate for each system point examined. The technician also records delay time.

The corresponding add-on rates for examined system points, the delay time multiplied by the delay time rate, and the base rate multiplied by the number of system points examined are added together to determine a billing amount. The examining technician is paid at least in part a percentage of the billing amount.

### BRIEF DESCRIPTION OF THE DRAWINGS

FIG. 1A is a high-level block diagram illustrating a system in accordance with one aspect of the present invention, the block diagram showing relationships between a technician, a service provider and a customer.

FIG. 1B is a high-level block diagram illustrating a system in accordance with one aspect of the present invention, the block diagram showing relationships between a technician, a service provider, a program provider and a customer.

FIG. 2A illustrates one example of a special condition/add-on rate table.

FIG. 2B illustrates an example of an alternative special condition/add-on rate table with additional entries for delay time and overtime.

FIG. 3 is a flowchart for one embodiment of a technician examination process.

### DETAILED DESCRIPTION OF THE PREFERRED EMBODIMENTS

Relationships Between The Parties

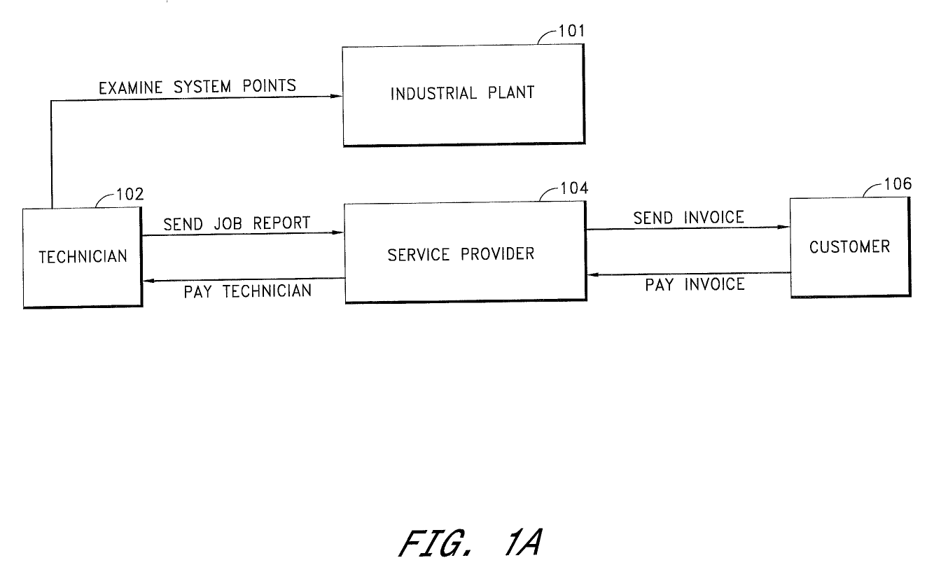

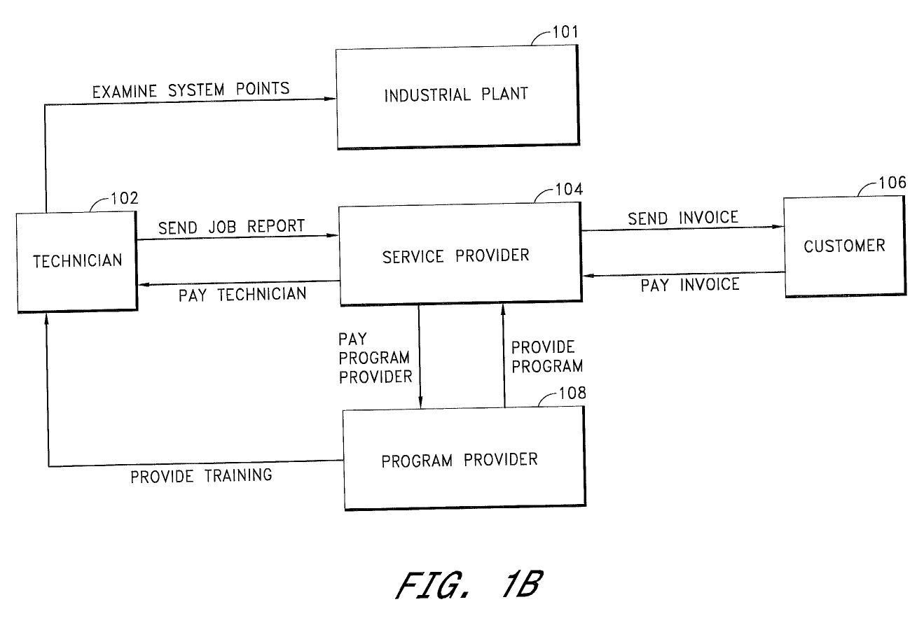

FIG. 1A is a high-level block diagram illustrating a system in accordance with one aspect of the present invention, in particular showing relationships between a technician, a service provider and a customer. Although only one technician 102, one service provider 104 and one customer 106 are shown for the simplicity of illustration, FIG. 1 also applies to the relationships between multiple technicians to a service provider, multiple service providers to a technician, multiple service providers to a customer, and multiple customers to a service provider.

The technician 102 examines a plurality of system points in an industrial plant 101 and sends a job report to the service provider 104. The service provider 104 creates an invoice based on the job report and sends the invoice to the customer 106. In one embodiment, the service provider 104 sends the job report to the customer 106 as the invoice. The customer 106 pays the invoice to the service provider 104. The service provider 104 pays at least a part of the invoice to the technician 102. In one embodiment, the technician 102 is paid a commission as a percentage of the billing amount included in the invoice. In another embodiment, the technician 102 is paid a percentage of the billing amount included in the invoice plus an hourly salary. In yet another embodiment, the technician 102 is paid a guaranteed hourly rate if an otherwise calculated payment amount would be less than the guaranteed hourly rate.

One skilled in the art will appreciate that one or more technicians 102 may contract independently with the customer 106 to perform the examination service, thus bypassing the service provider 104. Multiple technicians 102 may act as one entity and collectively contract with the customer 106 to perform the examination service. The claimed systems and methods may also be used in such contexts without the service provider 104. In such contexts, the technicians 102 send a job report and an invoice to the customer 106, and the customer 106 pays the invoice to the technicians 102.

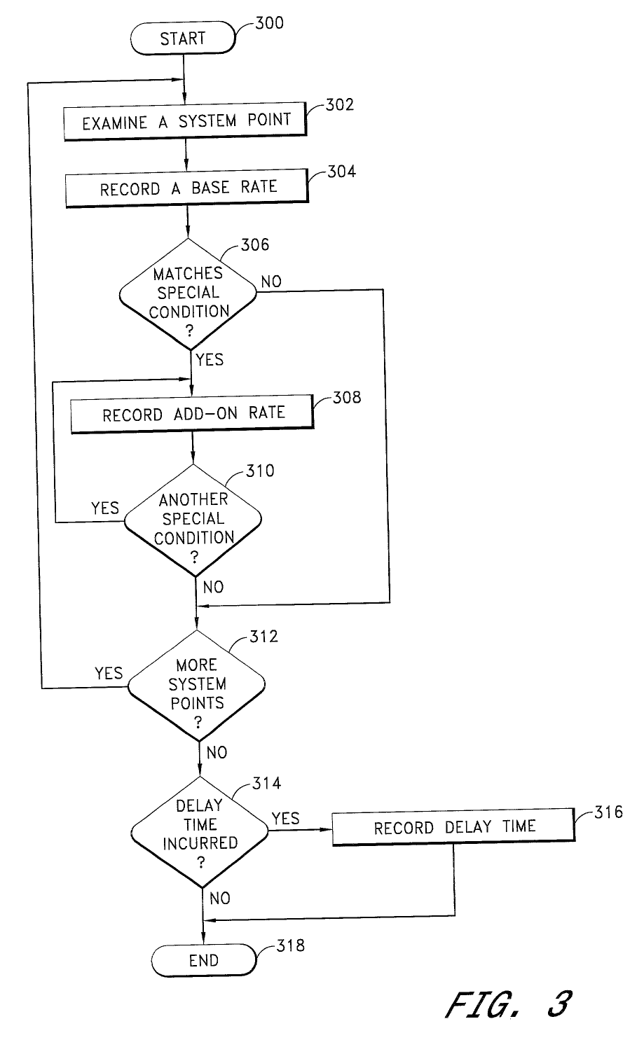

FIG. 1B is a high-level block diagram illustrating an alternative embodiment of a system of the present invention, in particular showing relationships between a technician, a service provider, a program provider and a customer. The program provider 108 trains the technicians 102 to carry out the technician examination process described below in connection with FIG. 3. The program provider 108 may also supply the technicians 102 with supplies for examining the system points and for recording the data, as described below in connection with FIG. 3. The program provider 108 also provides an assistance program to the service provider 104 that helps the service provider 104 in using the systems and methods described in the present application. The service provider 104 pays the program provider 108 for providing the assistance program and for training the technicians 102. In one embodiment the technicians 102 pay the program provider 108 for the training.

In one embodiment, the program provider 108 receives the job reports from the service provider 104 or from the technicians 102. The program provider 108 calculates the billing amount based on the job reports, and sends an invoice to the customer 106 or sends an invoice through the service provider 104 to the customer 106.

In one embodiment, the program provider 108 provides a web site application that may be utilized by the customer 106, the service provider 104 and the technician 102. The section below titled “Web Application” describes the web site application in more detail.

The following paragraphs will refer to the service provider 104, although it should be understood that the program provider 108 may perform part or all of the functions of the service provider 104.

Special Condition/Add-on Rate Pairs

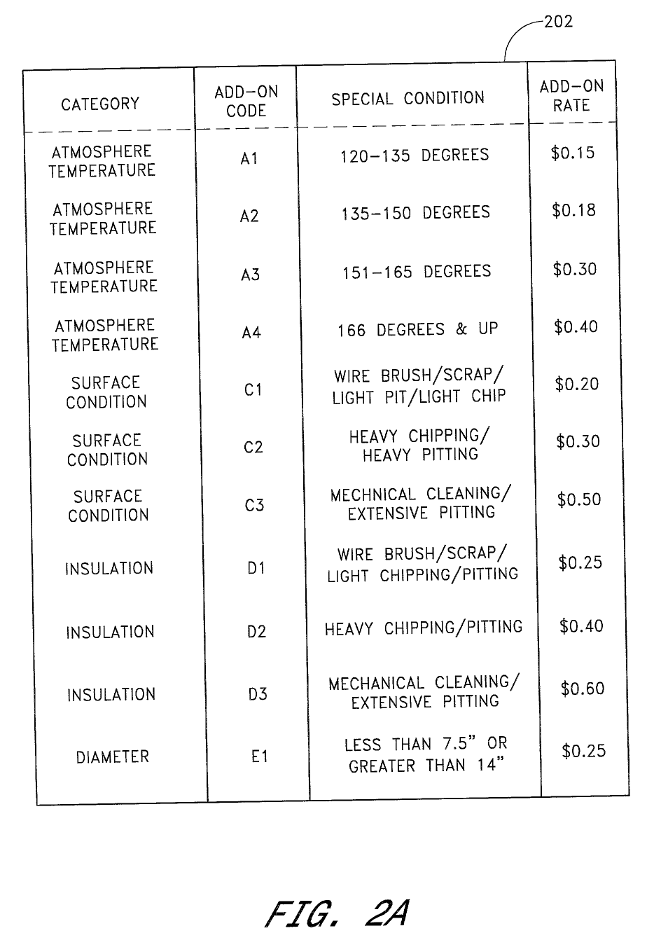

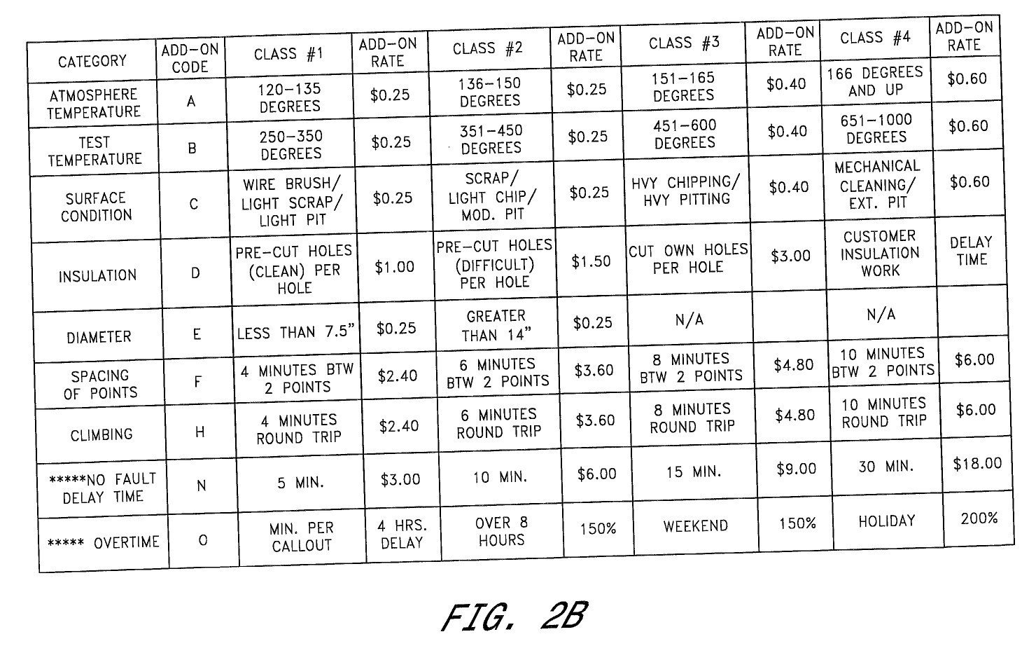

FIG. 2A illustrates one example of a special condition/add-on rate table 202 that stores special condition/add-on rate pairs. A special condition is a condition at a system point that requires longer than average time to complete an examination. Examples of special conditions may include a higher than average atmospheric temperature proximate to a system point, a higher than average surface temperature of a system point, a need to climb to the system point, a need to cut holes through insulation or remove insulation padding to examine the system point, a need to wear protective gear to examine the system point, a larger than average travel distance between system points, and so forth. An add-on rate is the associated rate that is added to a base rate when the respective special condition is encountered by the technician.

A “category” column is used to group special conditions into special condition categories, in order to help a technician locate a special condition in the table 202. The “category” and “special condition” columns of FIG. 2A may be combined into one column to identify special conditions. The “add-on code” column is used as abbreviated identification for the special condition/add-on rate pair.

FIG. 2B illustrates another example of a special condition/add-on rate table 202 with additional entries for delay time and overtime. Special conditions are grouped into categories, with each category having up to four special conditions. The four special conditions within a category are classified according to the degree of difficulty or the additional time requirements each presents to an examining technician. The “add-on code” column is used as an abbreviated identification for the category. A combination of the “add-on code” column and the “Class #” column is used as an abbreviated identification for the special condition/add-on rate pair. For example, “A1” may be used to identify the special condition of “atmosphere temperature of 120-135 degrees with an associated add-on rate of $0.25.”

FIG. 2B also includes additional entries for delay time and overtime. These entries are included in the table 202 to help the technician to remember and to record delay time and overtime. Delay time is non-productive time incurred by an examining technician through no-fault of the technician or the service provider. For example, if the customer is required to provide ladders for the technician to examine an above-ground system point, and the technician has to wait for ladders because the customer has neglected to provide them, then the technician has incurred delay time. In one embodiment, a condition that belongs to one of the special condition categories of the table 202 but does not match any of the special conditions for that category is to be recorded by the technician as delay time. For example, if a system point has test temperature higher than 1000 degrees, which exceeds the test temperature special conditions of FIG. 2B, then the technician may record the time spent on examining the system point as delay time. In another embodiment, the technician may wait until the test temperature drops to below 1000 degrees to proceed with examination, and record the waiting time as delay time.

Overtime is incurred when an examination is performed on days such as weekends and holidays, in which case the technician is paid and the customer is billed at an increased percentage. In one embodiment, overtime billing percentages are displayed as special conditions on FIG. 2B.

In one embodiment, special condition/add-on rate pairs may include negative add-on rates, also called discounts. Entries with negative add-on rates refer to special conditions that take less than average time to examine, so that the customer will be billed a rate less than the base rate (i.e., base rate plus the negative add-on rate) for the examination of each of such system points. Examples of special conditions that correspond to negative add-on rates may include smaller than average travel distance between system points, and other examples of system points that take less than average time to examine. One skilled in the art will appreciate that a method of using positive add-on rates may be equivalent to a method of using negative add-on rates coupled with a higher base rate.

Determining the Base Rate

The base rate for examining one system point may be determined by a brief inspection of the industrial plant by the service provider or the technician (for example, evaluating the size and complexity of the industrial plant, evaluating those examination requirements that are generally consistent throughout the industrial plant). The base rate may also be determined by examining the history of prior billing between the customer and the service provider or between the customer and another service provider.

In one embodiment, a primary base rate and a secondary base rate are used for examining an industrial plant having two types of system points. In another embodiment, more than two base rates are used, with each base rate associated with one type of system points. For each system point, the technician determines the type and records the respective base rate. For example, radiographic testing may include over a hundred types of radiographs. Each type of radiograph may be associated with a base rate.

In other embodiments, a base amount for examining all the system points in the industrial plant is determined. The base amount may be determined by inspecting the industrial plant, by examining the history of prior billing between the customer and the service provider or between the customer and another service provider, or by examining common pricing practice of the industry for similar industrial plants.

Technician Examination Process

FIG. 3 is a flowchart for one embodiment of a technician examination process. The process starts from a start state at a block 300 and proceeds to a block 302. At the block 302 the technician examines a system point. At a block 304 the technician records a base rate for the system point. In one embodiment, the technician records the base rate by incrementing the number of examined system points by one. In certain embodiments the technician also records a unit number and/or location of the system point, in order to identify the system point.

At a block 306, a determination is made as to whether the system point matches one or more of the special conditions in the special condition/add-on rate table 202. If the system point does not match a special condition, then the process proceeds to a block 312 to determine if more system points need to be examined. If the system point matches a special condition in the table 202, then the technician records the associated add-on rate at a block 308. In one embodiment, the technician records an add-on code as an abbreviated identification of the matched special condition/add-on rate pair in table 202. The technician may also record a brief description of the system point or the special condition.

In one embodiment, the technician also records the time spent on the special condition, or calculates and records an appropriate add-on rate for the time spent on the special condition. For example, if the technician spends 20 minutes of climbing time to examine a system point, the technician then consults FIG. 2B, records the special condition category (in this case “climbing”). The technician also records the time spent (i.e., 20 minutes) on climbing or an appropriate add-on rate (e.g., $12.00). The technician may also record a brief description of the special condition. Alternatively, the technician may record the climbing time as a delay time.

At a block 310, a determination is made as to whether the system point matches another special condition in the special condition/add-on rate table 202. If the system point does not match another special condition, then the process proceeds to the block 312. If the system point matches another special condition, then the technician records the respective add-on rate for the matched special condition at the block 308.

At the block 312 a determination is made as to whether more system points need to be examined. If more system points need to be examined, then the technician examines another system point at the block 302. If the technician has completed examining all system points, then the process proceeds to a block 314. At the block 314, a determination is made as to whether the technician has incurred delay time during the examination through no fault of the technician or the service provider. If delay time has been incurred, then the technician records the amount of delay time at a block 316. In addition the technician may also record the delay time billing rate, or calculate the delay time amount by multiplying the delay time with the delay time billing rate. The technician may also record a description that explains how was the delay time incurred.

In certain embodiments, the technician records the delay time for each system point. For example, in one embodiment, after the block 310 and before the block 312, the technician records the delay time incurred for the examined system point. In another embodiment, the technician records the delay time as a special condition (illustrated in FIG. 2B) at the blocks 306 and 308.

If no delay time has been incurred or if delay time has already been recorded, then the process proceeds to an end state at a block 318. In one embodiment, the technician also records overtime incurred during the examination. In addition, the technician may also record the overtime billing rate. In one embodiment, the technician records the overtime for examining each system point as a special condition (illustrated in FIG. 2B) at blocks 306 and 308.

In one embodiment of the above described process, the technician records the base rate (at the block 304), add-on rate (at the block 308) and delay time (at the block 316) on paper. In another embodiment, the technician records the base rate, add-on rate and delay time into an audio recording device (e.g., a hand-held audio recorder). In yet another embodiment, the technician records the base rate, add-on rate and delay time into a hand-held data entry device. The hand-held data entry device may be connected to a computer of the service provider. In one embodiment, the recorded content of the audio recording device may also be stored on a computer of the service provider. In one embodiment, the recorded content on paper may also be scanned into a computer of the service provider. The computer of the service provider may be connected to a web application of the service provider. Details of the web application is described below in the section titled “Web Application.”

In one embodiment of the above described process, the technician records the add-on rate but does not record the base rate for an examined system point if a special condition matches the system point. The technician also does not record the base rate for the system point if delay time has been incurred during the examination of the system point. The technician records the base rate for applicable system points, i.e., system points that do not match special conditions and do not incur delay time.

Calculation of Billing Amount

The base rate is added together for all applicable system points, or multiplied by the number of applicable system points. The result of the above described adding or multiplying is added to the add-on rates of all recorded special condition/add-on rate pairs to produce a final billing amount. In one embodiment, a delay time amount is also calculated and added to the final billing amount. The delay time amount is calculated by multiplying recorded delay time by the delay time billing rate. If overtime is incurred during the examination, then the billing amount for work performed on overtime is multiplied with an overtime percentage (typically 150% or 200%).

In one embodiment, the calculation of billing amount is made by the examining technician. In another embodiment, the service provider collects the base rate, add-on rates and the delay time recorded by the technician on paper, on an audio recording device or on a hand-held data entry device, and calculates the billing amount manually or automatically.

Determining Technician Efficiency and Expertise

In particular embodiments of the examination process, the technician records the time he or she spends on examining each system point. In one embodiment, the delay time for each system point is subtracted from the technician's examination time in order to better measure the technician's true working time. The examination time (with or without the delay time subtracted) for the system point and the special conditions/add-on rate pairs that correspond to the system point are entered into a file system or a computer database. The base rate for the system points may also be entered into the file system or the computer database. Additional information, such as system point category (for example pipe category, valve category, and so forth) and examination category (for example visual inspection, ultrasonic testing, radiological testing, liquid penetration testing, developing field drawings, and so forth), may also be entered into the file system or the computer database. The file system or the computer database may be connected to a web application.

Using the data entered into the file system or the computer database, the customer, the service provider or the technician may determine the technician's work efficiency and expertise. For example, by examining the ratios of (examination time/base rate), (examination time/add-on rates) and (examination time/(base rate+add-on rates)) for all system points, a technician's efficiency may be determined. A comparison of the above-described ratios for different technicians may help identify the most efficient technicians.

The above-described ratios may be calculated for each system point category and for each examination category, to determine a technician's efficiency and expertise. For example, one technician may be particularly efficient in examining pipes while another technician may be particularly efficient in examining vessels. One technician may be particularly efficient in ultrasonic testing while another technician may be particularly efficient in developing field drawings. The above-described ratios may also be calculated for each special condition or for each special condition category. Examples of special condition categories are illustrated in the “category” column of FIG. 2A and FIG. 2B. For example, one technician may be particularly efficient in examining system points with test temperature of 351-450 degrees. Another technician may be particularly efficient in examining all system points associated with any special condition in the “test temperature” category. The determination of efficiency and expertise allows the customer and the service provider to select the technician suitable for a particular type of examination.

The determination of efficiency and expertise also allows technicians to utilize their expertise and avoid or improve on their weakness. The determination of efficiency and expertise also allows the customer to monitor technicians' performance over time and allows the service provider to make informed technician training, employment and compensation decisions. In addition, it allows the service provider to manage technicians without field supervision.

In one embodiment, a technician's performance data is stored into a computer for measuring the technician's efficiency and expertise. The technician's performance data may include the time the technician spent on examining a system point (in one embodiment including delay time incurred for the system point, in another embodiment excluding delay time incurred for the system point) and the collection of special conditions, if any, that correspond to the system point. Additional performance data may include the examination category for the examination, the special condition categories for each special condition of the collection of special conditions, the add-on rates that correspond to each special condition of the collection of special conditions, the base rate for the system point, the system point category for the system point, the delay time incurred for the system point, and so forth. The performance data may be stored in one or more records, objects or other data structures. A number of data analysis calculations may be carried out on the stored performance data. The performance data may be maintained and analyzed by using commercial data storing and analyzing applications such as spreadsheet applications, Microsoft Access, Cold Fusion, SQL, Crystal Reports and others, or by using custom programs.

Web Application

In one embodiment, the service provider 104 or the program provider 108 maintains a web site that includes a web application. The work data recorded by the technicians in the process described below in connection with FIG. 3 are entered into the web site. The work data may be entered manually or automatically into the web site. The web application enables the technicians and the customer to review the entered data. In one embodiment, at least part of the work data is recorded on an audio recording device and entered into the web site as MP3 or another type of computer-accepted audio file. The recorded audio data may also be burned onto a recordable compact disk. The web application allows the customer to listen to the audio file to review the technician's work. Advantageously, the web application also creates a report for delay time incurred by each technician and associated explanations, and allows the customer to review the report. In preferred embodiments the web application also creates an invoice and reports on work performed to the customer based on the entered data. The web application enables the customer to review and to print the invoice and the reports. Additional capabilities of the web application may include a payroll module enabling the technicians to review anticipated compensation based on the entered work data and a job tracking module enabling the customer to review the status of examinations performed over time.

The web application may also include a job estimator module that determines each technician's efficiency and expertise. The process of determining each technician's efficiency and expertise is described in the preceding section. The job estimator module then identifies the most appropriate technician for a particular job.

Conclusion

Although the foregoing has been a description and illustration of specific embodiments of the invention, various modifications and changes can be made thereto by persons skilled in the art, without departing from the scope and spirit of the invention as defined by the following claims. The phrase “subset” as used in the claims may mean the complete set, a partial subset, or a null subset of the collection. The phrase “collection” as used in the claims may mean a null collection or a non-null collection. When implemented in an automated form, the invention may be implemented in part or in its entirety by computer software programs, computer hardware or a combination of the above.

What is claimed is:

1. A method of determining a final billing amount for examining a plurality of system points in an industrial plant, comprising:
determining a primary base rate;
determining a plurality of pairs of special conditions and respective add on rates (special condition/add-on rate pairs), each of said special condition/add-on rate pairs comprising an add-on rate and a special condition;
for each of said plurality of system points, determining a subset of said special condition/add-on rate pairs that correspond to said system point; and
for each of said plurality of system points, adding said add-on-rates in each special condition/add-on rate pair of said subset to said primary base rate to produce said final billing amount.

2. The method of claim 1, further comprising determining a secondary base rate, and wherein the step of adding said add-on rates comprises:
for each of said plurality of system points, determining an associated base rate, said associated base rate being equal to said primary base rate for a first subset of said plurality of system points and being equal to said secondary base rate for a second subset of said plurality of system points; and
for each of said plurality of system points, adding said add-on-rates in each special condition/add-on rate pair of said subset to said associated base rate to produce said final billing amount.

3. The method of claim 1, wherein the step of adding said add-on rates comprises:
for each of said plurality of system points, adding said add-on-rates in each special condition/add-on rate pair of said subset and a delay time billing amount for delay time incurred to said primary base rate to produce said final billing amount.

4. The method of claim 1, wherein said special condition/add-on rate pairs are grouped by special condition categories.

5. The method of claim 1, wherein said special condition/add-on rate pairs include a delay time/delay time billing rate pair as one of said special condition/add-on rate pairs.

6. The method of claim 1, wherein at least one of said plurality of special condition/add-on rate pairs includes a negative add-on rate.

7. A method of determining a final billing amount for examining a plurality of system points in an industrial plant, comprising:
determining a primary base rate;
determining a plurality of pairs of special conditions and respective add-on rates (special condition/add-on rate pairs), each of said special condition/add-on rate pairs comprising an add-on rate and a special condition;
determining a total number of system points for said plurality of system points;
multiplying said total number of system points with said primary base rate to produce a total base amount;
for each system point of said plurality of system points, determining a subset of said special condition/add-on rate pairs that correspond to said system point; and
for each special condition/add-on rate pair in said subset, adding said add-on rate of said special condition/add-on rate pair to said total base amount to produce said final billing amount.

8. A method of determining a final billing amount for examining a plurality of system points in an industrial plant, comprising:
determining a base amount;
determining a plurality of pairs of special conditions and respective add-on rates (special condition/add-on rate pairs), each of said special condition/add-on rate pairs comprising an add-on rate and a special condition;
for each of said plurality of system points, determining a subset of said special condition/add-on rate pairs that correspond to said system point;
for each of said plurality of system points, adding said add-on-rates in each special condition/add-on rate pair of said subset to produce a total add-on amount; and
adding said total add-on amount to said base amount to produce said final billing amount.

9. A method of determining a payment amount for compensating a technician for examining a plurality of system points in an industrial plant, comprising:
determining a primary base rate;
determining a plurality of pairs of special conditions and respective add-on rates (special condition/add-on rate pairs), each of said special condition/add-on rate pairs comprising an add-on rate and a special condition;
for each of said plurality of system points, determining a subset of said special condition/add-on rate pairs that correspond to said system point;
for each of said plurality of system points, adding said add-on-rates in each special condition/add-on rate pair of said subset to said primary base rate to produce a final billing amount; and
assigning a percentage of said final billing amount to a first part of said payment amount.

10. The method of claim 9, further comprising assigning an hourly rate multiplied by a number of hours worked to a second part of said payment amount.

11. A method of examining a system point in an industrial plant, comprising:
recording a base rate;
from a plurality of special condition/add-on rate pairs, finding a subset of special condition/add-on rate pairs that match said system point;
for each special condition/add-on rate pair of said subset, recording said add-on rate; and
recording delay time incurred for examining said system point.

12. The method of claim 11, further comprising recording an amount of time spent on examining said system point.

13. A method of examining a plurality of system points in an industrial plant, comprising:
for each of said plurality of system points, incrementing a number of examined system points by one;
from a plurality of special condition/add-on rate pairs, finding a subset of special condition/add-on rate pairs that match said system point;
recording each special condition/add-on rate pair of said subset; and
recording delay time incurred for examining said system point.

14. The method of claim 13, further comprising:
for each of said plurality of system points, recording an amount of time spent on examining said system point.

15. A data structure for storing work performance data of a technician in examining a system point in an industrial plant, comprising:
an examination time attribute for storing an amount of time said technician spent on said examining; and
a special condition attribute for storing a collection of special conditions that correspond to said system point.

16. The data structure of claim 15, wherein said data structure is a record.

17. The data structure of claim 15, wherein said data structure is an object.

18. The data structure of claim 15, further comprising an examination category attribute for storing a category value of said examining.

19. The data structure of claim 15, further comprising an add-on rate attribute for storing a collection of add-on rates that correspond to said collection of special conditions.

20. The data structure of claim 15, further comprising a base rate attribute.

21. The data structure of claim 15, further comprising a system point category attribute for storing a classification value of said system point.

22. A method of determining a final billing amount for examining a plurality of system points in an industrial plant, comprising:
determining a primary base rate;
determining a plurality of pairs of special conditions and respective add on rates (special condition/add-on rate pairs), each of said special condition/add-on rate pairs comprising an add-on rate and a special condition;
for each of said plurality of system points, determining a subset of said special condition/add-on rate pairs that correspond to said system point; and
for each of said plurality of system points, adding said add-on-rates in each special condition/add-on rate pair of said subset to said final billing amount if said subset is not empty; and
for each of said plurality of system points, adding said primary base rate to said final billing amount if said subset is empty.
